(19) United States
(12) Patent Application Publication
(10) Pub. No.: US 2018/0090085 A1
(43) Pub. Date: Mar. 29, 2018

(54) ELECTRO-OPTICAL DEVICE, METHOD OF CONTROLLING ELECTRO-OPTICAL DEVICE, AND ELECTRONIC APPARATUS

(71) Applicant: SEIKO EPSON CORPORATION, Tokyo (JP)

(72) Inventor: Shinta ENAMI, Matsumoto-shi (JP)

(73) Assignee: SEIKO EPSON CORPORATION, Tokyo (JP)

(21) Appl. No.: 15/696,257

(22) Filed: Sep. 6, 2017

(30) Foreign Application Priority Data
Sep. 29, 2016 (JP) 2016-190774

(51) Int. Cl. G09G 3/36

(52) U.S. Cl. CPC G09G 3/3614; G09G 3/3655; G09G 3/3677; G09G 3/3688; G09G 2310/0297; G09G 2310/027; G09G 2320/0271; G09G 2300/0876; G09G 2310/0251

(57) ABSTRACT

A data line driving circuit supplies an image signal having an amplitude according to gradation to be displayed to pixels via data lines in a gradation display period, and supplies a precharge voltage including a low-potential second voltage and a high-potential second voltage to the data lines in a precharge period before the gradation display period. A polarity inversion unit inverts polarity of the voltage applied to the pixel between positive polarity and negative polarity for each vertical scanning period. A control circuit performs control such that a supply period of a precharge voltage as a high-potential second voltage in the negative polarity is shorter than a supply period of a precharge voltage as a high-potential second voltage in the positive polarity.

### BACKGROUND

### 1. Technical Field

The present invention relates to an electro-optical device such as a liquid crystal device, a method of controlling an electro-optical device, and an electronic apparatus.

### 2. Related Art

Electro-optical devices for displaying an image using liquid crystal elements have been widely developed. In the electro-optical device, by supplying a voltage of an image signal designating display gradation of each pixel to each pixel via a data line, and controlling transmittance of a liquid crystal included in each pixel to transmittance according to the designated gradation of the image signal, the gradation designated by the image signal is displayed on each pixel.

However, in a case where the supply of the voltage to each pixel is insufficient, such as a case where it is difficult to secure a sufficient time for supplying the voltage of the image signal to each pixel, in some cases, each pixel cannot accurately display the gradation designated by the image signal, and as a result, display quality may deteriorate. In order to solve the problem in that the display quality deteriorates due to insufficient writing of the voltage of the image signal to the pixel, in the related art, the following measures have been proposed. For example, in JP-A-2010-102217, a technique that facilitates the writing of the voltage of the image signal to each pixel by outputting a precharge signal with a voltage close to the voltage of the image signal to each pixel and each data line before supplying the image signal, has been proposed.

The precharge signal is an auxiliary signal for writing a predetermined precharge voltage into VID signal lines or data lines, and is output to all of the VID signal lines or the data lines in advance before outputting the image signal. A period during which the precharge signal is output is called a precharge period. By writing a predetermined precharge voltage during the precharge period, it is possible to assist the writing of the voltage of the image signal or it is possible to improve image quality.

In the technique using the precharge signal, a driving method called two-stage precharge driving by which a precharge signal with a low voltage is supplied before supplying a precharge signal with a high voltage close to the voltage of the image signal, has also been proposed (for example, JP-A-2010-102217). According to the two-stage precharge driving, it is possible to realize both of image quality improvement and writing assistance.

However, as resolution of the electro-optical device increases, the number of scanning lines and data lines increases. For this reason, it is necessary to shorten a horizontal scanning period. As a result, there is a tendency that a sufficient precharge period for supplying the precharge signal cannot be secured.

### SUMMARY

An advantage of some aspects of the invention is to provide an electro-optical device capable of shortening a horizontal scanning period and performing high-resolution display and high-quality display while securing a sufficient precharge period, a method of controlling the electro-optical device, and an electronic apparatus including the electro-optical device.

According to an aspect of the invention, there is provided an electro-optical device including: a plurality of scanning lines; a plurality of data lines; pixels provided corresponding to intersections between the plurality of scanning lines and the plurality of data lines; a scanning line driving unit that supplies scanning signals to the scanning lines; a data line driving unit that supplies a first voltage having an amplitude according to gradation to be displayed to the pixels via the data lines in a first period, and that supplies a second voltage including a low-potential second voltage and a high-potential second voltage to the data lines in a second period before the first period; a polarity inversion unit that inverts polarity of the voltage applied to the pixel between positive polarity and negative polarity for each vertical scanning period; and a control unit that controls the data line driving unit such that a supply period of the high-potential second voltage in the negative polarity is shorter than a supply period of the high-potential second voltage in the positive polarity.

According to the aspect of the invention, the first voltage having an amplitude corresponding to the gradation to be displayed is supplied from the data line driving unit to the pixels via the data lines in the first period. In addition, before the supply of the first voltage, the second voltage including the low-potential second voltage and the high-potential second voltage is supplied to the data lines in the second period before the first period. In addition, by sequentially supplying the low-potential second voltage and the high-potential second voltage as the second voltage, both of image quality improvement and writing assistance are realized. Further, in the aspect of the invention, the polarity of the voltage applied to the pixel is inverted between the positive polarity and the negative polarity. The positive polarity or the negative polarity of the voltage applied to the pixel is defined by an amplitude of the voltage with respect to the center voltage of the voltage. The voltage higher than the center voltage has the positive polarity, and the voltage lower than the center voltage has the negative polarity. Thus, for example, a voltage difference between the low-potential second voltage and the high-potential second voltage in the negative polarity is smaller than a voltage difference between the low-potential second voltage and the high-potential second voltage in the positive polarity. Therefore, even in a case where the supply period of the high-potential second voltage in the negative polarity is shorter than the supply period of the high-potential second voltage in the positive polarity, it is possible to sufficiently supply the high-potential second voltage to the data lines. Furthermore, in the aspect of the invention, the control unit performs control such that the supply period of the high-potential second voltage in the negative polarity is shorter than the supply period of the high-potential second voltage in the positive polarity. Thus, it is possible to shorten a horizontal scanning period in a negative polarity period. As described above, according to the aspect of the invention, it is possible to shorten the horizontal scanning period while securing a sufficient precharge period, and it is possible to perform high-resolution display and high-quality display.

In the electro-optical device according to the aspect, the data line driving unit may include a voltage amplification unit and a D/A conversion unit. According to the aspect of the invention, in the first period, digital data representing the gradation is converted into a first analog voltage by the D/A conversion unit, and the first analog voltage is output to the data lines by the voltage amplification unit. In addition, in the second period, digital data representing the second voltage which includes the low-potential second voltage for improving image quality and the high-potential second voltage for writing assistance, is converted into a second analog voltage by the D/A conversion unit, and the second analog voltage is supplied to the data lines by the voltage amplification unit. Therefore, by supplying the digital data representing the high-potential second voltage at an appropriate timing and appropriately controlling the supply period of the high-potential second voltage to the data lines, it is possible to change the supply period of the high-potential second voltage in the positive polarity and the negative polarity.

In the electro-optical device according to the aspect, the first period may include a gradation display period, the second period may include a fly-back period, and the second voltage may include a precharge voltage. According to the aspect of the invention, in the gradation display period, the first voltage is written into the pixels via the data lines, and in the fly-back period, the precharge voltage is written into the data lines. Therefore, it is possible to secure a writing period of the precharge voltage to the data lines while securing a sufficient writing period of the first voltage to the pixels.

In the electro-optical device according to the aspect, a data line selection unit that is provided between the data line driving unit and the data lines and selects the data lines in a time division manner, may be further included. According to the aspect of the invention, since the data lines are selected by the data line selection unit in a time division manner, even in a case where the number of the pixels, that is, the number of the scanning lines and the data lines increases according to high resolution, as described above, it is possible to shorten one horizontal scanning period. Therefore, it is possible to reliably write the first voltage and the second voltage.

According to another aspect of the invention, there is provided a method of controlling an electro-optical device including a plurality of scanning lines, a plurality of data lines, and pixels provided corresponding to intersections between the plurality of scanning lines and the plurality of data lines, the method including: supplying scanning signals to the scanning lines in a first period; supplying a first voltage having an amplitude according to gradation to be displayed to the pixels via the data lines in the first period; supplying a second voltage including a low-potential second voltage and a high-potential second voltage to the data lines in a second period before the first period; inverting polarity of the voltage applied to the pixel between positive polarity and negative polarity for each vertical scanning period; and performing control such that a supply period of the high-potential second voltage in the negative polarity is shorter than a supply period of the high-potential second voltage in the positive polarity.

According to the aspect of the invention, the first voltage having an amplitude corresponding to the gradation to be displayed is supplied from the data line driving unit to the pixels via the data lines in the first period. In addition, before the supply of the first voltage, the second voltage including the low-potential second voltage and the high-potential second voltage is supplied to the data lines in the second period before the first period. In addition, by sequentially supplying the low-potential second voltage and the high-potential second voltage as the second voltage, both of image quality improvement and writing assistance are realized. Further, in the aspect of the invention, the polarity of the voltage applied to the pixel is inverted between the positive polarity and the negative polarity. The positive polarity or the negative polarity of the voltage applied to the pixel is defined by an amplitude of the voltage with respect to the center voltage of the voltage. The voltage higher than the center voltage has the positive polarity, and the voltage lower than the center voltage has the negative polarity. Thus, for example, in a case where 0 V is considered as a reference, a voltage difference between the low-potential second voltage and the high-potential second voltage in the negative polarity is smaller than a voltage difference between the low-potential second voltage and the high-potential second voltage in the positive polarity. Therefore, even in a case where the supply period of the high-potential second voltage in the negative polarity is shorter than the supply period of the high-potential second voltage in the positive polarity, it is possible to sufficiently supply the high-potential second voltage to the data lines. Furthermore, in the aspect of the invention, the control unit performs control such that the supply period of the high-potential second voltage in the negative polarity is shorter than the supply period of the high-potential second voltage in the positive polarity. Thus, it is possible to shorten a horizontal scanning period in a negative polarity period. As described above, according to the aspect of the invention, it is possible to shorten the horizontal scanning period while securing a sufficient precharge period, and it is possible to perform high-resolution display and high-quality display.

According to still another aspect of the invention, there is provided an electronic apparatus including the electro-optical device according to the aspect of the invention. According to the electronic apparatus, in a display device such as a liquid crystal display, one horizontal scanning period can be shortened, and thus it is possible to reliably write the first voltage and the second voltage. Therefore, it is possible to provide an electronic apparatus with high image quality.

### BRIEF DESCRIPTION OF THE DRAWINGS

The invention will be described with reference to the accompanying drawings, wherein like numbers reference like elements.

FIG. 1 is an explanatory diagram of an electro-optical device according to an embodiment of the invention.

FIG. 2 is a block diagram illustrating a configuration of the electro-optical device according to the embodiment.

FIG. 3 is a circuit diagram illustrating a configuration of a pixel.

FIG. 4 is a block diagram illustrating a configuration of a data line driving circuit.

FIG. 5 is a diagram schematically illustrating an output waveform of the data line driving circuit in positive polarity driving.

FIG. 6 is a diagram schematically illustrating an output waveform of the data line driving circuit in negative polarity driving.

FIG. 7 is a timing chart of a driving integrated circuit.

FIG. 8 is an explanatory diagram illustrating an example of an electronic apparatus.

FIG. 9 is an explanatory diagram illustrating another example of an electronic apparatus.

FIG. 10 is an explanatory diagram illustrating still another example of an electronic apparatus.

### DESCRIPTION OF EXEMPLARY EMBODIMENTS

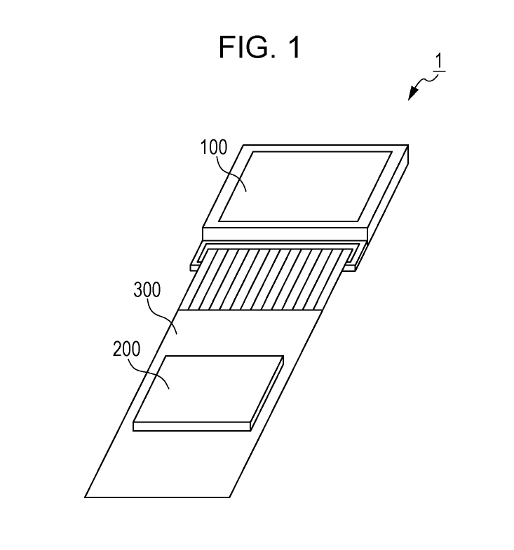

An embodiment according to the invention will be described with reference to FIGS. 1 to 7. FIG. 1 is a diagram illustrating a configuration of a signal transmission system of an electro-optical device 1. As illustrated in FIG. 1, the electro-optical device 1 includes an electro-optical panel 100, a driving integrated circuit (driver IC) 200, and a flexible printed circuit board 300, and the electro-optical panel 100 is connected to the flexible printed circuit board 300 on which the driving integrated circuit 200 is mounted. The electro-optical panel 100 is connected to a board of a host CPU apparatus (not illustrated) via the flexible printed circuit board 300 and the driving integrated circuit 200. The driving integrated circuit 200 is a device that receives an image signal and various control signals for driving control from the host CPU apparatus via the flexible printed circuit board 300 and drives the electro-optical panel 100 via the flexible printed circuit board 300.

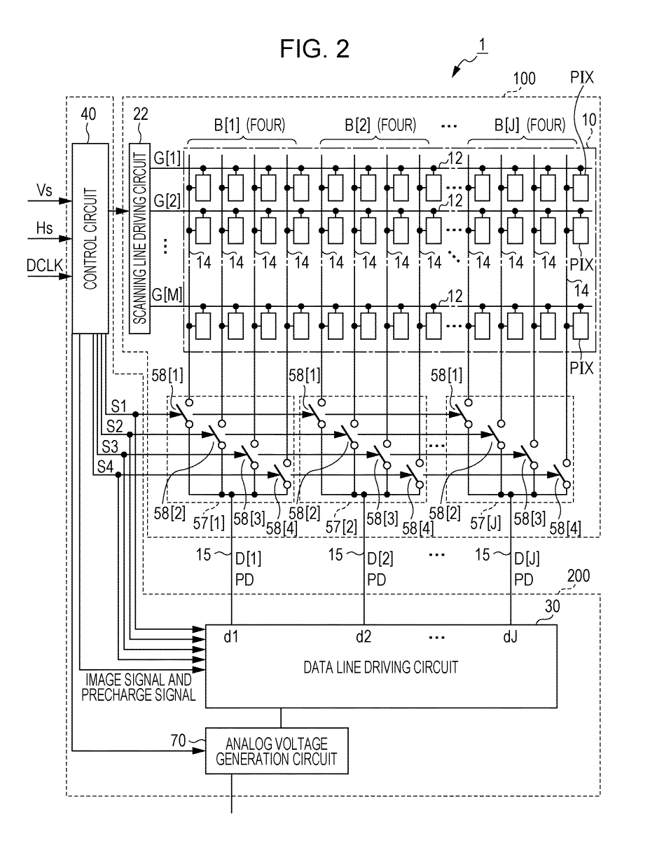

FIG. 2 is a block diagram illustrating configurations of the electro-optical panel 100 and the driving integrated circuit 200. As illustrated in FIG. 2, the electro-optical panel 100 includes a pixel unit 10, a scanning line driving circuit 22 as a scanning line driving unit, and J demultiplexers 57[1] to 57[J] as a data line selection unit (J is a natural number). The driving integrated circuit 200 includes a data line driving circuit 30 as a data line driving unit, a control circuit 40 as a control unit, and an analog voltage generation circuit 70.

In the pixel unit 10, M scanning lines 12 and N data lines 14 that intersect with each other are formed (M and N are natural numbers). A plurality of pixel circuits (pixels) PIX are provided corresponding to respective intersections between the respective scanning lines 12 and the respective data lines 14, and are arranged in a matrix shape of M rows in the longitudinal direction×N columns in the transverse direction.

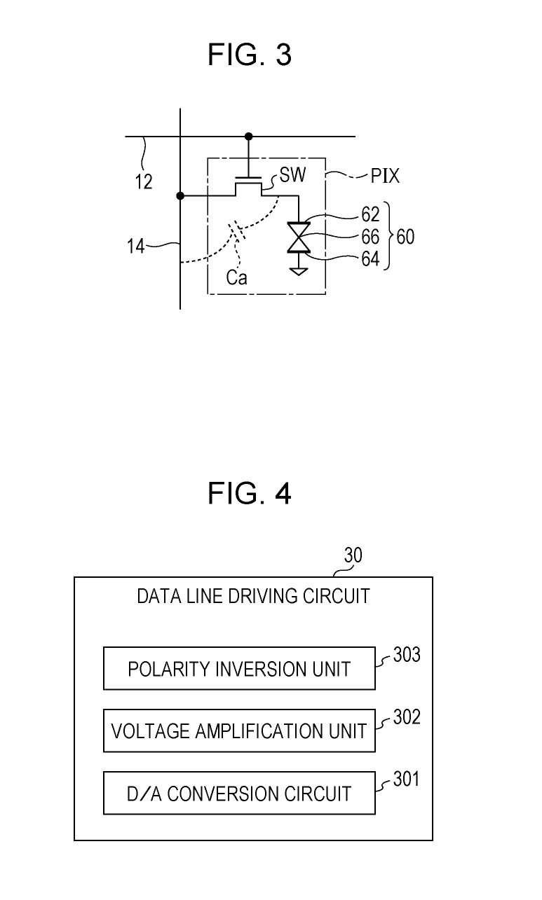

FIG. 3 is a circuit diagram of each pixel circuit PIX. As illustrated in FIG. 3, each pixel circuit PIX includes a liquid crystal element 60 and a switching element SW such as a TFT. The liquid crystal element 60 is an electro-optical element that is configured with a pixel electrode 62 and a common electrode 64 which are opposed to each other and a liquid crystal 66 interposed between both electrodes. Transmittance (display gradation) of the liquid crystal 66 changes according to a voltage applied between the pixel electrode 62 and the common electrode 64. A configuration in which an auxiliary capacitor is connected to the liquid crystal element 60 in parallel, may be adopted. The switching element SW is configured with, for example, an N-channel type transistor of which the gate is connected to the scanning line 12. The switching element SW is provided between the liquid crystal element 60 and the data line 14, and controls electrical connection (conduction/non-conduction) between the liquid crystal element 60 and the data line 14. When a scanning signal G[m] is set to selection potential, the switching element SW of each pixel circuit PIX in the m-th row simultaneously transitions to an ON state (m is a natural number of 1 to M).

When the scanning line 12 corresponding to the pixel circuit PIX is selected and the switching element SW of the pixel circuit PIX is controlled to become an ON state, a voltage according to a data signal D[n] (n is a natural number from 1 to J) which is supplied from the data line 14 to the pixel circuit PIX, is applied to the liquid crystal element 60. As a result, transmittance of the liquid crystal 66 of the pixel circuit PIX is set to transmittance according to the data signal D[n]. When a light source (not illustrated) becomes an ON (turn-on) state and light is emitted from the light source, the light passes through the liquid crystal 66 of the liquid crystal element 60 included in the pixel circuit PIX, and proceeds toward an observer. That is, when the voltage according to the data signal D[n] is applied to the liquid crystal element 60 and the light source becomes an ON state, the pixel corresponding to the pixel circuit PIX displays gradation according to the data signal D[n].

After the voltage according to the data signal D[n] is applied to the liquid crystal element 60 of the pixel circuit PIX, when the switching element SW becomes an OFF state, ideally, the applied voltage corresponding to the data signal D[n] is held. Therefore, ideally, each pixel displays the gradation according to the data signal D[n] during a period from when the switching element SW becomes an ON state to when the switching element SW becomes an ON state next time.

As illustrated in FIG. 3, parasitic capacitance Ca is present between the data line 14 and the pixel electrode (or between the data line 14 and wiring for electrically connecting the pixel electrode 62 and the switching element SW). For this reason, during a period for which the switching element SW is in an OFF state, there is a case where a change in potential of the data line 14 propagates to the pixel electrode 62 via the capacitance Ca and the applied voltage of the liquid crystal element 60 changes.

In addition, a common voltage LCCOM, which is a constant voltage, is supplied to the common electrode 64 via a common line (not illustrated). As the common voltage LCCOM, a voltage with a difference of approximately −0.5 V with respect to the center voltage of an amplitude of the data signal D[n], is used. This is due to characteristics of the switching element SW and the like.

In the present embodiment, in order to prevent so-called ghosting, polarity inversion driving that inverts polarity of the voltage applied to the liquid crystal element 60 for each vertical scanning period (1V), is adopted. In this example, a level of the data signal D[n] supplied to the pixel circuit PIX via the data line 14 is inverted with respect to the center voltage of the data signal D[n], for each vertical scanning period (1V). Here, the period during which the polarity is inverted may be arbitrarily set, and for example, may be a natural number times the one vertical scanning period V. In the present embodiment, a case where the voltage of the data signal D[n] becomes a higher voltage than the center voltage thereof is represented as positive polarity, and a case where the voltage of the data signal D[n] becomes a lower voltage than the center voltage thereof is represented as negative polarity.

Returning to FIG. 2, external signals such as a vertical synchronization signal Vs that defines a vertical scanning period V, a horizontal synchronization signal Hs that defines a horizontal scanning period H, and a dot clock signal DCLK are input to the control circuit 40 from an external host CPU apparatus (not illustrated). The control circuit 40 performs synchronization control of the scanning line driving circuit 22 and the data line driving circuit 30 based on the signals. Under the synchronization control, the scanning line driving circuit 22 and the data line driving circuit 30 control display of the pixel unit 10 in cooperation with each other.

Typically, display data constituting one display screen is processed in a frame unit, and the processing period is one frame period (1F). The frame period F corresponds to the vertical scanning period V in a case where one display screen is formed by one vertical scanning.

The scanning line driving circuit 22 outputs scanning signals G[1] to G[M] to the respective M scanning lines 12. In response to output of the horizontal synchronization signal Hs from the control circuit 40, the scanning line driving circuit 22 sequentially sets the scanning signals G[1] to G[M] for the respective scanning lines 12, to an active level, for one horizontal scanning period (1H), within the vertical scanning period V.

Here, during a period for which the scanning signal G[m] corresponding to the m-th row is set to an active level and the scanning line corresponding to the m-th row is selected, the respective switching elements SW of the N pixel circuits PIX in the m-th row become an ON state. As a result, the respective N data lines 14 are electrically connected to the respective pixel electrodes 62 of the N pixel circuits PIX in the m-th row via the respective switching elements SW.

In the present embodiment, the N data lines 14 in the pixel unit 10 are divided into J wiring blocks B[1] to B[J] (J=N/4) each with four data lines 14 as a unit that are adjacent to each other. In other words, the data lines 14 are grouped for each wiring block B. The demultiplexers 57[1] to 57[J] correspond to the J wiring blocks B[1] to B[J], respectively. As will be described later, in the present embodiment, since the data lines 14 are divided into units each with four data lines 14, the data signal D[n] includes a data voltage for four pixels.

Each demultiplexer 57[j] as the data line selection unit is configured with four switches 58[1] to 58[4] (j is a natural number from 1 to J). In each demultiplexer 57[j], one contact of each of the four switches 58[1] to 58[4] is commonly connected to a point. The point, which is commonly connected to the one contact of each of the four switches 58[1] to 58[4] in each demultiplexer 57[j], is connected to each of J VID signal lines 15. The J VID signal lines 15 are connected to the data line driving circuit 30 of the driving integrated circuit 200 via the flexible printed circuit board 300.

In addition, in each demultiplexer 57[j], the other contact of each of the four switches 58[1] to 58[4] is connected to each of the four data lines 14 constituting the wiring block B[j] corresponding to the demultiplexer 57[j]. ON/OFF of each of the four switches 58[1] to 58[4] in each demultiplexer 57[j] is switched by each of four selection signals S1 to S4. The four selection signals S1 to S4 are supplied from the control circuit 40 of the driving integrated circuit 200 via the flexible printed circuit board 300. Here, for example, in a case where one selection signal S1 becomes an active level and the other three selection signals S2 to S4 become a non-active level, the J switches 58[1] belonging to each demultiplexer 57[j] become an ON state. Thus, each demultiplexer 57[j] outputs each of the data signals D[1] to D[J] on the J VID signal lines 15, to the first data line 14 of each of the wiring blocks B[1] to B[J]. Thereafter, in the same manner, each demultiplexer 57[j] outputs each of the data signals D[1] to D[J] on the J VID signal lines 15, to the second, third, and fourth data lines 14 of each of the wiring blocks B[1] to B[J].

The control circuit 40 includes a frame memory, and has at least an M×N-bit memory space corresponding to resolution of the pixel unit 10. The control circuit 40 stores and holds display data which is input from the external host CPU apparatus (not illustrated) in frame units. Here, the display data which defines gradation of the pixel unit 10 is, for example, 64-gradation data with six bits. The display data which is read from the frame memory is transmitted to the data line driving circuit 30 by serial transmission via a six-bit bus, as an image signal.

The control circuit 40 may be configured to include a line memory for at least one line. In this case, display data for one line is stored in the line memory, and the display data is transmitted to each pixel, as an image signal.

The data line driving circuit 30 as the data line driving unit outputs the data signals to be supplied for each row of the pixels to which data is written, to the data lines 14, in cooperation with the scanning line driving circuit 22. The data line driving circuit 30 generates a latch signal based on the selection signals S1 to S4 output from the control circuit 40, and sequentially latches a precharge signal and N six-bit image signals that are supplied as serial data. The image signals are grouped as time-series signals every four pixels.

FIG. 4 is a block diagram illustrating a configuration of the data line driving circuit 30. As illustrated in FIG. 4, the data line driving circuit 30 is provided with a digital to analog (D/A) conversion circuit 301 as a D/A conversion unit, a voltage amplification unit 302, and a polarity inversion unit 303. The D/A conversion circuit 301 performs D/A conversion based on the grouped image signals and an analog voltage which is generated by the analog voltage generation circuit 70 and of which the voltage value is set by the polarity inversion unit 303. In addition, the voltage amplification unit 302 amplifies the voltage generated by the D/A conversion, and generates a data signal having a predetermined analog voltage. Thus, image signals which are arranged in a time-series manner in a unit of four pixels, is converted into the data signal D[n] having a predetermined data voltage (first voltage). In addition, the precharge signal is similarly converted into a precharge data signal PD having a predetermined precharge voltage (second voltage), and a set of the precharge data signal PD and the data signal D[n] for four pixels is supplied to each VID signal line 15 in this order.

The polarity inversion unit 303 inverts polarity of the voltage of the precharge data signal PD and polarity of the voltage of the data signal D[n], for each vertical scanning period V. Specifically, the polarity inversion unit 303 inverts the voltage of the precharge data signal PD and the voltage of the data signal D[n], with respect to the center voltage of the data signal D[n], for each vertical scanning period V. Here, a period during which the polarity is inverted may be arbitrarily set, and for example, may be a natural number times the vertical scanning period V. In the present embodiment, a case where the voltage of the data signal D[n] becomes a higher voltage than the center voltage thereof is represented as positive polarity, and a case where the voltage of the data signal D[n] becomes a lower voltage than the center voltage thereof is represented as negative polarity. The polarity inversion unit 303 sets voltage values of the data voltage (first voltage) and the precharge voltage (second voltage) according to the polarity.

In each demultiplexer 57[j], conduction (ON/OFF) of each of the switches 58[1] to 58[4] is controlled by each of the selection signals S1 to S4 output from the control circuit 40, and each of the switches 58[1] to 58[4] becomes an ON state at a predetermined timing. During a period for which the precharge signal is applied, conduction of each of the switches 58[1] to 58[4] is controlled by each of the selection signals S1 to S4 output from the control circuit 40, and the switches 58[1] to 58[4] of the demultiplexer 57[j] simultaneously become an ON state.

Thus, in one horizontal scanning period (1H), the precharge data signal PD and the data signal D[n] for four pixels that are supplied to each VID signal line 15, are output to the data lines 14 in a time-series manner by the switches 58[1] to 58[4].

In the present embodiment, polarity inversion driving is adopted and two-stage precharge driving is adopted, and thus four types of precharge voltages are used as the precharge voltage of the precharge data signal PD. The precharge means to write a predetermined voltage into all of the VID signal lines 15 and the data lines 14 in advance before writing the data voltage of the data signal D[n] to the data lines 14. In addition, the two-stage precharge driving means precharge driving which performs a first-stage precharge and a second-stage precharge in stages. In the first-stage precharge, a level of the precharge voltage is set to, for example, a voltage level for black display (low-potential second voltage) in order to prevent crosstalk in the longitudinal direction. In the second-stage precharge, a level of the precharge voltage is set to, for example, a voltage level of halftone (high-potential second voltage) in order to assist writing by the data line driving circuit 30.

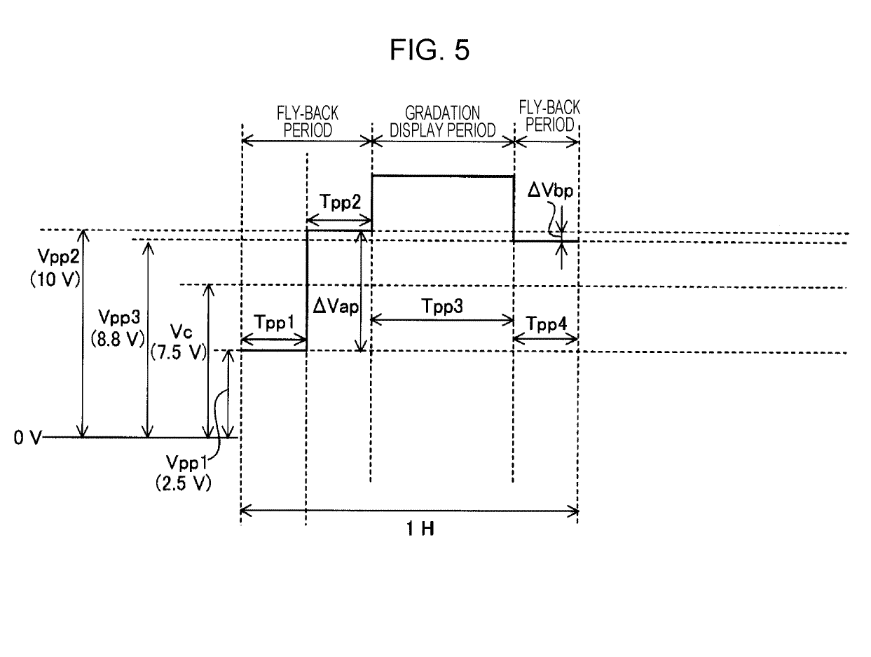

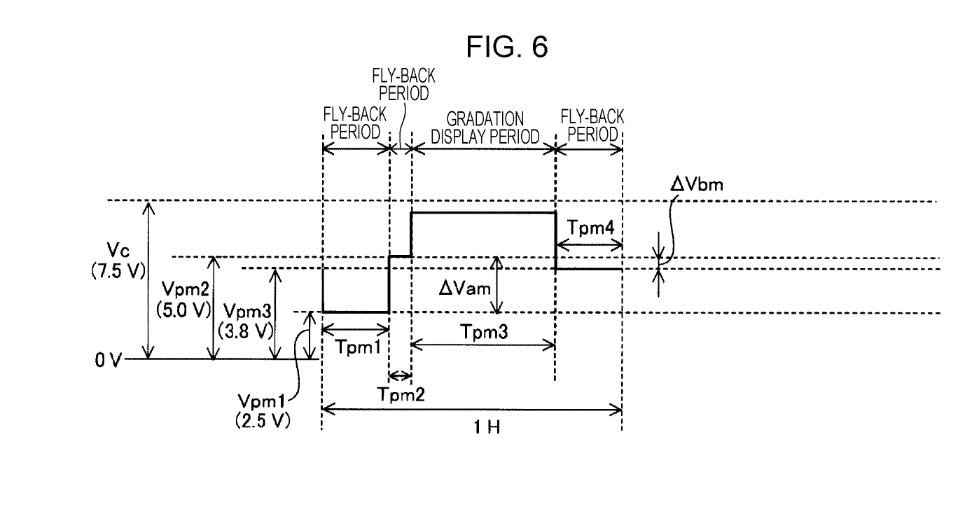

In the present embodiment, the control circuit 40 controls the polarity inversion driving such that a second-stage precharge period in the negative polarity driving is shorter than a second-stage precharge period in the positive polarity driving. Hereinafter, a precharge driving method according to the present embodiment will be described in detail with reference to FIGS. 5 and 6.

FIG. 5 is a diagram illustrating an outline of the precharge data signal PD output to the VID signal lines 15 during the positive polarity driving. FIG. 6 is a diagram illustrating an outline of the precharge data signal PD output to the VID signal lines 15 during the negative polarity driving. In FIG. 5 and FIG. 6, for the sake of convenience, the data signal D[n] which is output in a gradation display period is illustrated as a constant voltage.

As illustrated in FIG. 5, in the two-stage precharge driving when performing the positive polarity driving, one horizontal scanning period (1H) is divided into a gradation display period Tpp3 as a first period and a fly-back period as a second period. Further, the fly-back period is divided into a first-stage precharge period Tpp1, a second-stage precharge period Tpp2, and a post-precharge period Tpp4. The first-stage precharge is performed for a purpose of improving image quality, and the precharge data signal PD with the low-potential second voltage is supplied to the VID signal lines 15. The second-stage precharge is performed for a purpose of assisting writing of the data voltage of the data signal D[n], and the precharge data signal PD with the high-potential second voltage is supplied to the VID signal lines 15. The post-precharge is performed for a purpose of improving gradation dependence when performing precharge. Since the data voltage of the data signal D[n] which is output in the gradation display period Tpp3 changes depending on the gradation, when the precharge is performed immediately after the data signal D[n] is supplied, a voltage difference between the data voltage of the data signal D[n] and the precharge voltage of the precharge data signal PD changes. As a result, in a case of gradation before the precharge, writing of the precharge voltage of the precharge data signal PD into the data line 14 may not be completed within a predetermined period. Therefore, by writing a constant post-precharge voltage of the precharge data signal PD into the data line 14 after end of the gradation display period Tpp3, it is possible to reliably write the precharge voltage into the data line 14 without depending on gradation before the precharge.

As illustrated in FIG. 6, in the two-stage precharge driving when performing the negative polarity driving, one horizontal scanning period (1H) is divided into a gradation display period Tpm3 as a first period and a fly-back period as a second period. Further, the fly-back period is divided into a first-stage precharge period Tpm1, a second-stage precharge period Tpm2, and a post-precharge period Tpm4.

In the present embodiment, as an example, the polarity inversion unit 303 sets a first-stage precharge voltage Vpp1 in the positive polarity driving to 2.5 V, and sets a center voltage Vc in the positive polarity driving to 7.5 V. In addition, the polarity inversion unit 303 sets a second-stage precharge voltage Vpp2 in the positive polarity driving to 10.0 V, and sets a post-precharge voltage Vpp3 in the positive polarity driving to 8.8 V. In addition, the polarity inversion unit 303 sets a first-stage precharge voltage Vpm1 in the negative polarity driving to 2.5 V, and sets a second-stage precharge voltage Vpm2 in the negative polarity driving to 5.0 V. Further, the polarity inversion unit 303 sets a post-precharge voltage Vpm3 in the negative polarity driving to 3.8 V. Each voltage value is not limited to the above-mentioned voltage value, and may be appropriately changed.

Here, a voltage difference between the second-stage precharge voltage and a voltage immediately before the second-stage precharge voltage will be described. As illustrated in FIG. 5, in the positive polarity driving, a voltage immediately before the second-stage precharge voltage Vpp2 is the first-stage precharge voltage Vpp1, and a voltage difference ΔVap between the second-stage precharge voltage Vpp2 and the first-stage precharge voltage Vpp1 is as follows.

ΔVap=Vpp2−Vpp1=10.0−2.5=7.5 [V]

In addition, as illustrated in FIG. 6, in the negative polarity driving, a voltage immediately before the second-stage precharge voltage Vpm2 is the first-stage precharge voltage Vpm1, and a voltage difference ΔVam between the second-stage precharge voltage Vpm2 and the first-stage precharge voltage Vpm1 is as follows.

ΔVam=Vpm2−Vpm1=5.0−2.5=2.5 [V]

When considering only a capacitive load of the data line 14 and a resistive load of the data line 14, a ratio between a time required for writing of the second-stage precharge voltage Vpp2 in the positive polarity driving and a time required for writing of the second-stage precharge voltage Vpm2 in the negative polarity driving is as follows. The ratio is a ratio between the voltage difference ΔVap and the voltage difference ΔVam, and is expressed as follows.

Voltage Difference ΔVam/Voltage Difference ΔVap=2.5/7.5=1/3

That is, the writing of the second-stage precharge voltage Vpm2 in the negative polarity driving can be completed in one third of the writing of the second-stage precharge voltage Vpp2 in the positive polarity driving.

Here, in the present embodiment, the control circuit 40 performs control such that the second-stage precharge period Tpm2 in the negative polarity driving is shorter than the second-stage precharge period Tpp2 in the positive polarity driving. As an example, the second-stage precharge period Tpp2 in the positive polarity driving is set to 250 ns to 270 ns, and on the other hand, the second-stage precharge period Tpm2 in the negative polarity driving is set to 80 ns to 90 ns.

In this way, by making the second-stage precharge period Tpm2 in the negative polarity driving shorter than the second-stage precharge period Tpp2 in the positive polarity driving, one horizontal scanning period (1H) in the negative polarity driving can be shorter than one horizontal scanning period (1H) in the positive polarity driving.

Therefore, even in a case where resolution of the electro-optical device 1 increases and the number of the data lines 14 and the scanning lines 12 increases, it is possible to write the data voltage of the image signal into the data line 14 in the short horizontal scanning period H while securing a writing period of the precharge voltage of the precharge data signal PD.

Control of the precharge period is realized by output of the control signal and the precharge signal from the control circuit 40 to the data line driving circuit 30. The data line driving circuit 30 includes a latch circuit. By outputting the precharge signal from the control circuit 40 to the data line driving circuit 30 at a predetermined timing and outputting the latch signal, it is possible to control the precharge period to be a desired period.

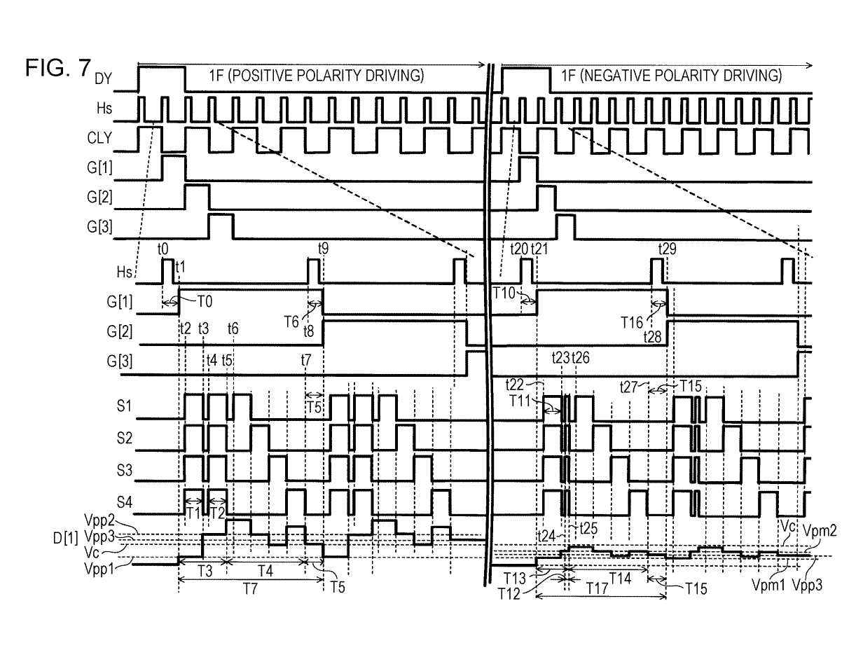

Next, an example of control according to the present embodiment will be described with reference to FIG. 7. FIG. 7 illustrates a timing chart. In the example illustrated in FIG. 7, positive polarity driving is performed in the first one frame (1F), and negative polarity driving is performed in the next one frame (1F). In addition, FIG. 7 illustrates scanning signals G[1], G[2], and G[3] among the scanning signals.

When the horizontal synchronization signal Hs is input from the external host CPU apparatus to the control circuit 40, the control circuit 40 drives the scanning line driving circuit 22 in synchronization with the horizontal synchronization signal Hs. The scanning line driving circuit 22 generates the scanning signals G[1], G[2], . . . , and G[M] by sequentially shifting a signal corresponding to a Y transmission start pulse DY in the one frame (1F) period in accordance with a Y clock signal CLY. The scanning signals G[1], G[2], . . . , and G[M] sequentially become an active level in each horizontal scanning period H. The data line driving circuit 30 generates sampling pulses SP1, SP2, . . . , and SPz (not illustrated) based on an X transmission start pulse DX (not illustrated) in the horizontal scanning period and an X clock signal CLX (not illustrated).

The data line driving circuit 30 outputs the precharge data signal PD with a predetermined precharge voltage to the VID signal lines 15 based on the precharge signal. In addition, the data line driving circuit 30 generates the data signals D[1] to D[J] by sampling the image signal corresponding to the display data supplied from the external host CPU apparatus using sampling pulses SP1, SP2, . . . , and SPz (not illustrated). The voltages of the data signals D[1] to D[J] are set to predetermined data voltages.

The control circuit 40 outputs the selection signals S1 to S4 to the data line driving circuit 30 and the four switches 58[1] to 58[4] of each demultiplexer 57[j] in synchronization with the horizontal synchronization signal Hs. The data line driving circuit 30 outputs the precharge data signal PD and the data signals D[1] to D[J], from the output terminals d1 to dJ to the VID signal lines 15. The four switches 58[1] to 58[4] of each demultiplexer 57[j] become an ON/OFF state based on the selection signals S1 to S4.

At a timing t1 after an elapse of a period T0 from a timing t0 at which the horizontal synchronization signal Hs becomes an active level, the control circuit 40 sets the scanning signal G[1] to an active level. In addition, at the timing t1, the control circuit 40 outputs the first-stage precharge signal with the low-potential second voltage in the positive polarity driving, to the data line driving circuit 30. The data line driving circuit 30 generates the precharge data signal PD with the first-stage precharge voltage Vpp1 in the positive polarity driving by sampling the first-stage precharge signal using the sampling pulses SP1, SP2, . . . , and SPz (not illustrated). The data line driving circuit 30 outputs the precharge data signal PD with the first-stage precharge voltage Vpp1 in the positive polarity driving, from the output terminals d1 to dJ to the VID signal lines 15.

At a timing t2, the control circuit 40 outputs the selection signals S1 to S4 for simultaneously turning on the switches 58[1] to 58[4], in synchronization with the horizontal synchronization signal Hs. Thus, in a period T1, the first-stage precharge voltage Vpp1 in the positive polarity driving is written into all of the VID signal lines 15 and the data lines 14.

At a timing t3 after an elapse of the period T1 from the timing t2, the control circuit 40 outputs the selection signals S1 to S4 for simultaneously turning off the switches 58[1] to 58[4]. The period T1 is a supply period of the first-stage precharge voltage Vpp1 in the positive polarity driving.

In addition, at the timing t3, the control circuit 40 outputs the second-stage precharge signal with the high-potential second voltage in the positive polarity driving, to the data line driving circuit 30.

The data line driving circuit 30 generates the precharge data signal PD with the second-stage precharge voltage Vpp2 in the positive polarity driving by sampling the second-stage precharge signal using the sampling pulses SP1, SP2, . . . , and SPz (not illustrated). The data line driving circuit 30 outputs the precharge data signal PD with the second-stage precharge voltage Vpp2 in the positive polarity driving, from the output terminals d1 to dJ to the VID signal lines 15.

At a timing t4, the control circuit 40 outputs the selection signals S1 to S4 for simultaneously turning on the switches 58[1] to 58[4], in synchronization with the horizontal synchronization signal Hs. Thus, the second-stage precharge voltage Vpp2 in the positive polarity driving is written into all of the VID signal lines 15 and the data lines 14.

At a timing t5 after an elapse of a period T2 from the timing t4, the control circuit 40 outputs the selection signals S1 to S4 for simultaneously turning off the switches 58[1] to 58[4]. The period T2 is a supply period of the second-stage precharge voltage Vpp2 in the positive polarity driving. A period T3 from the timing t1 to the timing t5 is the entire precharge period in the positive polarity driving.

In addition, at the timing t5, the control circuit 40 outputs the image signals corresponding to the display data supplied from the external host CPU apparatus, to the data line driving circuit 30.

The data line driving circuit 30 generates the data signals D[1] to D[J] by sampling the image signal using sampling pulses SP1, SP2, . . . , and SPz (not illustrated). The voltages of the data signals D[1] to D[J] are set to predetermined data voltages. The data line driving circuit 30 outputs the data signals D[1] to D[J] from the output terminals d1 to dJ to the VID signal lines 15.

After a timing t6, the control circuit 40 outputs the selection signals S1 to S4 to the data line driving circuit 30 and the four switches 58[1] to 58[4] of each demultiplexer 57[j] in synchronization with the horizontal synchronization signal Hs. The four switches 58[1] to 58[4] of each demultiplexer 57[j] become an ON/OFF state based on the selection signals S1 to S4, and the data signals D[1] to D[J] are respectively output to the data lines 14.

A period T4 from the timing t5 when the data signals D[1] to D[J] are output to the VID signal lines 15 to a timing t7 when the selection signal S4 becomes an OFF level, is a gradation display period.

At the timing t7 when the selection signal S4 becomes an OFF level, the control circuit 40 outputs the post-precharge signal with the post-precharge voltage in the positive polarity driving, to the data line driving circuit 30.

A period T5 from the timing t7 when the selection signal S4 becomes an OFF level to a timing t9 when the scanning signal G[2] becomes an active level, is a post-precharge period in the positive polarity driving. In the post-precharge period, the selection signals S1 to S4 remain in an OFF level. On the other hand, the post-precharge voltage Vpp3 with a constant voltage can be charged to wiring right in front of the switches 58[1] to 58[4] (corresponding to the VID signal lines 15), regardless of the displayed gradation. Thus, it is possible to shorten a writing time of the first-stage precharge voltage Vpp1 in the next horizontal scanning period, regardless of the displayed gradation.

At the timing t9 after an elapse of a period T6 from a timing t8 when the next horizontal synchronization signal Hs becomes an active level, the control circuit 40 sets the scanning signal G[1] to a non-active level and sets the scanning signal G[2] to an active level at the same time. A period T7 from the timing t1 when the scanning signal G[1] becomes an active level to the timing t9 when the scanning signal G[2] becomes an active level, is one horizontal scanning period corresponding to the first-row scanning line (1H). Thereafter, in the same manner, the precharge data signal PD and the data signals D[1] to D[J] are respectively output to the data lines 14.

When one frame (1F) in which the positive polarity driving is performed is ended, next one frame (1F) in which the negative polarity driving is performed is started. In one frame (1F) in which the negative polarity driving is performed, the control circuit 40 performs control such that a period of the horizontal synchronization signal Hs supplied from the external host CPU apparatus is shorter than a period of the horizontal synchronization signal Hs in one frame (1F) in which the positive polarity driving is performed. Specifically, since the second-stage precharge period in the negative polarity driving is shorter than the second-stage precharge period in the positive polarity driving, the period of the horizontal synchronization signal Hs is shortened according to the shortening of the second-stage precharge period in the negative polarity driving.

At a timing t21 after an elapse of a period T10 from a timing t20 at which the horizontal synchronization signal Hs becomes an active level, the control circuit 40 sets the scanning signal G[1] to an active level. In addition, at a timing t21, the control circuit 40 outputs the first-stage precharge signal with the low-potential second voltage in the negative polarity driving, to the data line driving circuit 30. The data line driving circuit 30 generates the precharge data signal PD with the first-stage precharge voltage Vpm1 in the negative polarity driving by sampling the first-stage precharge signal using the sampling pulses SP1, SP2, . . . , and SPz (not illustrated). The data line driving circuit 30 outputs the precharge data signal PD with the first-stage precharge voltage Vpm1 in the negative polarity driving, from the output terminals d1 to dJ to the VID signal lines 15.

At a timing t22, the control circuit 40 outputs the selection signals S1 to S4 for simultaneously turning on the switches 58[1] to 58[4], in synchronization with the horizontal synchronization signal Hs. Thus, in a period T11, the first-stage precharge voltage Vpm1 in the negative polarity driving is written into all of the VID signal lines 15 and the data lines 14.

At a timing t23 after an elapse of the period T11 from the timing t22, the control circuit 40 outputs the selection signals S1 to S4 for simultaneously turning off the switches 58[1] to 58[4]. The period T11 is a supply period of the first-stage precharge voltage Vpm1 in the negative polarity driving.

In addition, at the timing t23, the control circuit 40 outputs the second-stage precharge signal with the high-potential second voltage in the negative polarity driving, to the data line driving circuit 30.

The data line driving circuit 30 generates the precharge data signal PD with the second-stage precharge voltage Vpm2 in the negative polarity driving by sampling the second-stage precharge signal using the sampling pulses SP1, SP2, . . . , and SPz (not illustrated). The data line driving circuit 30 outputs the precharge data signal PD with the second-stage precharge voltage Vpm2 in the negative polarity driving, from the output terminals d1 to dJ to the VID signal lines 15.

At a timing t24, the control circuit 40 outputs the selection signals S1 to S4 for simultaneously turning on the switches 58[1] to 58[4], in synchronization with the horizontal synchronization signal Hs. Thus, the second-stage precharge voltage Vpm2 in the negative polarity driving is written into all of the VID signal lines 15 and the data lines 14.

At a timing t25 after an elapse of a period T12 from the timing t24, the control circuit 40 outputs the selection signals S1 to S4 for simultaneously turning off the switches 58[1] to 58[4]. The period T12 is a supply period of the second-stage precharge voltage Vpm2 in the negative polarity driving. The period T12 is set to be shorter than the supply period T2 of the second-stage precharge voltage Vpp2 in the positive polarity driving. A period T13 from the timing t20 to the timing t25 is the entire precharge period in the negative polarity driving.

In addition, at the timing t25, the control circuit 40 outputs the image signals corresponding to the display data which is input from the external host CPU apparatus, to the data line driving circuit 30.

The data line driving circuit 30 generates the data signals D[1] to D[J] by sampling the image signal using sampling pulses SP1, SP2, . . . , and SPz (not illustrated). The voltages of the data signals D[1] to D[J] are set to predetermined data voltages. The data line driving circuit 30 outputs the data signals D[1] to D[J] from the output terminals d1 to dJ to the VID signal lines 15.

After a timing t26, the control circuit 40 outputs the selection signals S1 to S4 to the data line driving circuit 30 and the four switches 58[1] to 58[4] of each demultiplexer 57[j] in synchronization with the horizontal synchronization signal Hs. The four switches 58[1] to 58[4] of each demultiplexer 57[j] become an ON/OFF state based on the selection signals S1 to S4, and the data signals D[1] to D[J] are respectively output to the data lines 14. A period T14 from the timing t25 when the data signals D[1] to D[J] are output to the VID signal lines 15 to a timing t27 when the selection signal S4 becomes an OFF level, is a gradation display period.

At the timing t27 when the selection signal S4 becomes an OFF level, the control circuit 40 outputs the post-precharge signal with the post-precharge voltage in the negative polarity driving, to the data line driving circuit 30.

A period T15 from the timing t27 when the selection signal S4 becomes an OFF level to a timing t28 when the scanning signal G[2] becomes an active level, is a post-precharge period in the negative polarity driving. In the post-precharge period, the selection signals S1 to S4 remain in an OFF level. On the other hand, the post-precharge voltage Vpm3 with a constant voltage can be charged to wiring right in front of the switches 58[1] to 58[4] (corresponding to the VID signal lines 15), regardless of the displayed gradation. Thus, it is possible to shorten a writing time of the first-stage precharge voltage Vpm1 in the next horizontal scanning period, regardless of the displayed gradation.

At the timing t29 after an elapse of a period T16 from a timing t28 when the next horizontal synchronization signal Hs becomes an active level, the control circuit 40 sets the scanning signal G[1] to a non-active level and sets the scanning signal G[2] to an active level at the same time. A period T17 from the timing t21 when the scanning signal G[1] becomes an active level to the timing t29 when the scanning signal G[2] becomes an active level, is one horizontal scanning period corresponding to the first-row scanning line 12 (1H). Thereafter, in the same manner, the precharge data signal PD and the data signals D[1] to D[J] are respectively output to the data lines 14.

As described above, the precharge data signal PD and the data signals D[1] to D[J] are output to the data lines 14 in one horizontal scanning period (1H) of one frame (1F) in which the negative polarity driving is performed.

As is apparent from FIG. 7, the period T12 which is the supply period of the second-stage precharge voltage Vpm2 in the negative polarity driving, is set to be shorter than the period T2 which is the supply period of the second-stage precharge voltage Vpp2 in the positive polarity driving. Therefore, the period T17 which is one horizontal scanning period (1H) in the negative polarity driving is shorter than the period T7 which is one horizontal scanning period H in the positive polarity driving. On the other hand, the period T4 which is the gradation display period in the positive polarity driving is the same as the period T14 which is the gradation display period in the negative polarity driving. In addition, the period T5 which is the post-precharge period in the positive polarity driving is the same as the period T15 which is the post-precharge period in the negative polarity driving.

As described above, in the present embodiment, in the two-stage precharge driving, the supply period of the second-stage precharge voltage Vpm2 in the negative polarity driving is shorter than the supply period of the second-stage precharge voltage Vpp2 in the positive polarity driving. This is because, as described above, the voltage difference between the first-stage precharge voltage Vpm1 and the second-stage precharge voltage Vpm2 in the negative polarity driving is smaller than the voltage difference between the first-stage precharge voltage Vpp1 and the second-stage precharge voltage Vpp2 in the positive polarity driving. Thus, according to the present embodiment, it is possible to shorten one horizontal scanning period H in the negative polarity driving while securing a sufficient writing period of the second-stage precharge voltage Vpm2 in the negative polarity driving. As described above, according to the present embodiment, it is possible to secure the required gradation display period and the required post-precharge period in both of the positive polarity driving and the negative polarity driving. In addition, it is possible to sufficiently secure the required precharge period in both of the positive polarity driving and the negative polarity driving, by the two-stage precharge.

According to the present embodiment, even in a case where driving capability of the driving integrated circuit (driver IC) is not improved or the number of components of the driving integrated circuit is not increased, it is possible to shorten one horizontal scanning period (1H) while securing the precharge period. Therefore, in a case where the number of components of the driving integrated circuit is increased, it is possible to further shorten one horizontal scanning period (1H) and to drive the high-definition electro-optical panel 100 with high precision.

### Modification Example

The invention is not limited to the above-described embodiment, and for example, various modifications to be described below may be made. In addition, it goes without saying that each embodiment and each modification example may be appropriately combined with each other.

(1) In the above-described embodiment, the horizontal synchronization signal Hs supplied from the external host CPU apparatus changes in accordance with the positive polarity driving and the negative polarity driving. On the other hand, the invention is not limited to such a configuration, and the control circuit 40 may perform control so as to shorten one horizontal scanning period (1H) in the negative polarity driving based on the constant horizontal synchronization signal Hs.

(2) In the above-described embodiment, an aspect in which the second-stage precharge period in the negative polarity driving is shorter than the second-stage precharge period in the positive polarity driving, is described. On the other hand, the invention is not limited to such an aspect. In the negative polarity driving, the precharge may be performed only in the first-stage precharge period by omitting the second-stage precharge period. This is based on a fact that the voltage difference between the first-stage precharge voltage and the second-stage precharge voltage in the negative polarity driving is small.

(3) In the above-described embodiment, although the liquid crystal is used as an example of an electro-optical material, the invention can also be applied to an electro-optical device using an electro-optical material other than the liquid crystal. The electro-optical material is a material of which the optical properties such as transmittance and luminance change by supply of an electric signal (current signal or voltage signal). For example, the invention can also be applied to a display panel using a light-emitting element such as an organic electroluminescent (EL), an inorganic EL, or a light-emitting polymer, as in the above-described embodiment. The invention can also be applied to an electrophoretic display panel using a microcapsule as an electro-optical material that includes a colored liquid and white particles dispersed in the liquid, as in the above-described embodiment. In addition, the invention can also be applied to a twisted ball display panel using a twist ball as an electro-optical material that is painted in different colors for each region with different polarity, as in the above-described embodiment. The invention can also be applied to various electro-optical devices such as a toner display panel using a black toner as an electro-optical material, or a plasma display panel using high-pressure gas such as helium or neon as an electro-optical material, as in the above-described embodiment.

### Application Example

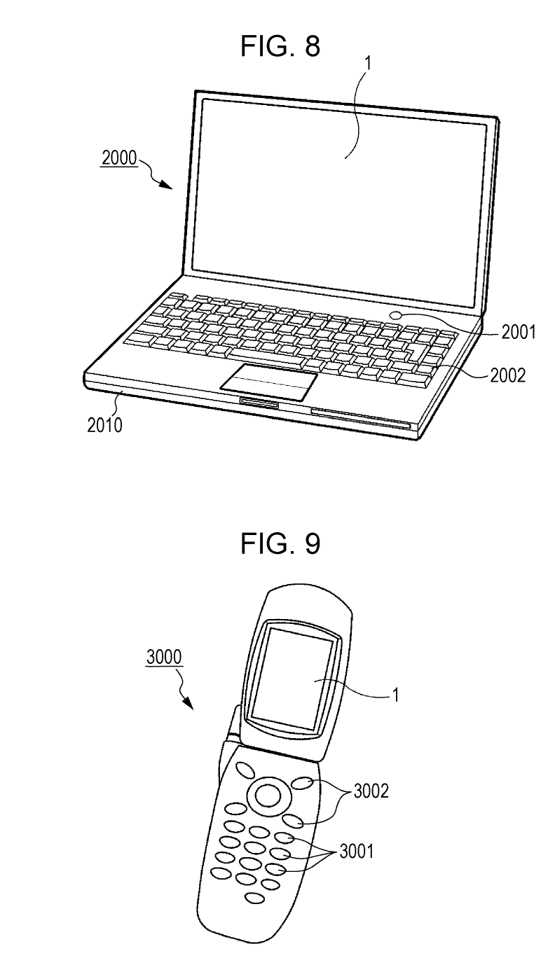

The invention can be used for various electronic apparatuses. FIGS. 8 to 10 illustrate specific forms of electronic apparatuses to which the invention is applied.

FIG. 8 is a perspective view of a portable personal computer to which an electro-optical device is adopted. The personal computer 2000 includes an electro-optical device 1 for displaying various images, and a main body unit 2010 on which a power switch 2001 and a keyboard 2002 are mounted.

FIG. 9 is a perspective view of a mobile phone. A mobile phone 3000 includes a plurality of operation buttons 3001 and scroll buttons 3002, and an electro-optical device 1 for displaying various images. When the scroll button 3002 is operated, a screen displayed on the electro-optical device 1 is scrolled. The invention can also be applied to such a mobile phone.

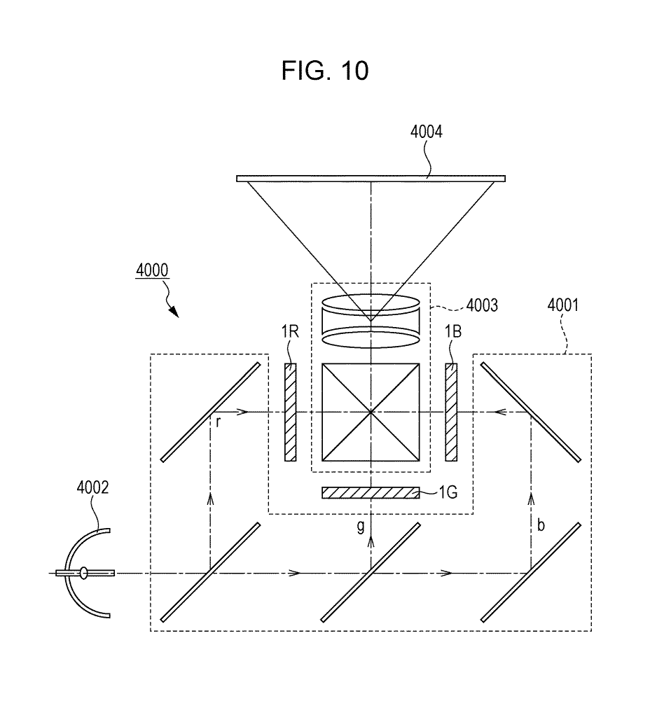

FIG. 10 is a schematic diagram illustrating a configuration of a projection type display apparatus (three-plate type projector) 4000 to which the electro-optical device is adopted. The projection type display apparatus 4000 includes three electro-optical devices 1 (1R, 1G, and 1B) corresponding to each of display colors R, G, and B different from each other. An illumination optical system 4001 supplies red components r of light emitted from an illumination device (light source) 4002 to the electro-optical device 1R, supplies green components g of the light to the electro-optical device 1G, and supplies blue components b of the light to the electro-optical device 1B. Each of the electro-optical devices 1 functions as an optical modulator (light valve) that modulates monochromatic light supplied from the illumination optical system 4001 according to the display image. A projection optical system 4003 combines the light emitted from the respective electro-optical devices 1, and projects the combined light on a projection surface 4004. The invention can also be applied to such a liquid crystal projector.

The electronic apparatuses to which the invention is applied include a personal digital assistants (PDA), in addition to the apparatuses illustrated in FIG. 1, and FIGS. 8 to 10. Further, the electronic apparatuses include a digital still camera, a television, a video camera, a car navigation apparatus, an in-vehicle display apparatus (instrument panel), an electronic organizer, an electronic paper, a calculator, a word processor, a workstation, a video phone, and a POS terminal. Furthermore, the electronic apparatuses include a printer, a scanner, a copier, a video player, an apparatus including a touch panel, and the like.

This application claims priority to Japan Patent Application No. 2016-190774 filed Sep. 29, 2016, the entire disclosures of which are hereby incorporated by reference in their entireties.

What is claimed is:

1. An electro-optical device comprising:
a scanning line;
a data line;
a pixel provided corresponding to intersection between the scanning line and the data line;
a scanning line driving circuit that supplies scanning signals to the scanning line;
a data line driving circuit that supplies a first voltage having an amplitude according to gradation to be displayed to the pixel via the data line in a first period, and that supplies a second voltage including a low-potential second voltage and a high-potential second voltage to the data line in a second period before the first period; and
a polarity inversion circuit that inverts polarity of the voltage applied to the pixel between positive polarity and negative polarity for each vertical scanning period,
wherein a supply period of the high-potential second voltage in the negative polarity is shorter than a supply period of the high-potential second voltage in the positive polarity.

2. The electro-optical device according to claim 1,
wherein the data line driving circuit includes a voltage amplification circuit and a D/A conversion circuit.

3. The electro-optical device according to claim 1,
wherein the first period includes a gradation display period, the second period includes a fly-back period, and the second voltage includes a precharge voltage.

4. The electro-optical device according to claim 1, further comprising:
a data line selection circuit that is provided between the data line driving circuit and a plurality of the data lines and selects a plurality of the data lines in a time division manner.

5. A method of controlling an electro-optical device including scanning lines, data lines, and a pixel provided corresponding to intersection between one scanning line of the scanning lines and one data line of data lines intersect with each other, the method comprising:
supplying scanning signals to the scanning line;
supplying a first voltage having an amplitude according to gradation to be displayed to the pixel via the data line in a first period;
supplying a second voltage including a low-potential second voltage and a high-potential second voltage to the data line in a second period before the first period; and
inverting polarity of the voltage applied to the pixel between positive polarity and negative polarity for each vertical scanning period,
wherein a supply period of the high-potential second voltage in the negative polarity is shorter than a supply period of the high-potential second voltage in the positive polarity.

6. An electronic apparatus comprising:
the electro-optical device according to claim 1.
